(19) United States
(12) Patent Application Publication
(10) Pub. No.: US 2004/0109947 A1
(43) Pub. Date: Jun. 10, 2004

(54) Stain resistant coatings for flexible substrates, substrates coated therewith and related methods

(76) Inventors: Raymond J. Weinert JR., Macedonia, OH (US); Pamela Cadile, Beloit, OH (US); Haruhiko Mohri, Osaka-shi (JP); Katsuhiko Imoto, Osaka (JP)

Correspondence Address: David G. Burleson, Esq., OMNOVA Solutions Inc., 175 Ghent Road, Fairlawn, OH, 44333, US

(21) Appl. No.: 10/315,285

(22) Filed: Dec. 9, 2002

(51) Int. Cl. C14C 9/00; B05D 3/02; B32B 27/00

(52) U.S. Cl. 427/372.2; 428/421; 428/480; 428/500; 252/8.57

(57) ABSTRACT

The present invention is related to the production of coatings utilizing a fluorine-containing polymer having hydroxyl and/or carboxyl groups that are cured with an amino resin to produce “soft hand” low gloss coatings for vinyl, urethane, leather, and other flexible plastic substrates. A method for increasing the stain resistance of a flexible substrate comprises providing a fluorine-containing ethylene-based copolymer containing fluorine atoms in the main chain of the polymer and pendent reactive groups selected from the group consisting of carboxyl groups, hydroxyl groups and combinations thereof; providing an amino resin; mixing the copolymer and the amino resin; applying the mixed copolymer and amino resin to a flexible substrate; and curing the mixed copolymer and amino resin to provide a coated substrate having a soft hand wherein the stain resistance of said coated substrate is improved over that of the uncoated substrate.

### BACKGROUND OF THE INVENTION

This invention relates to the use of stain resistant coatings that also provides excellent tactile “hand” when applied to flexible substrates. More particularly, this invention relates to the use of fluorine-containing polymers with reactive hydroxyl and/or carboxyl groups cured using an amino compound. The coatings provide a low gloss appearance and good tactile feel and may be cleaned with isopropanol when stained.

The use of fluorinated compounds to provide stain-resistant coatings for various surfaces is well known in the art. Fluorine-containing polymers (or fluoropolymers) are also known for other properties which are desirable in applications involving outdoor use such as surface hardness and gloss retention. Such properties are not universally desirable, however, and the usefulness of fluoropolymers varies with the demands of a particular application. For example, a fluorine-containing ethylene-imine based composition may be used to provide a water and oil repellant layer for a suede-like polyurethane structure. This composition, however, is unsuitable for use with natural materials, such as suede or velour leather.

One composition for the electro-deposition of paint comprises a water-dispersable and electrophoretic fluoropolymer and an aminoplast. The fluoropolymer contains carboxyl groups which must be neutralized with a base to render the fluoropolymer suitable for electrodeposition.

Other uses for fluoropolymers have also been described. A “wet-on-wet” process for forming a multi-layer protective coating includes a fluoropolymer layer. Another multi-layer, stain-resistant film comprises an “interpenetrating polymer network (IPN) layer,” and a layer containing a fluoropolymer.

A fluorine-containing copolymer containing a structural group of the formula —CF₂—CFX— is known. The copolymer is used with acrylic copolymers and is desribed as providing a film with high weatherability. Similar co-polymers have also been used in paints to improve stain resistance.

The removal of stains in paints is improved using high levels, often greater than 60 weight percent, of an organo-metallic fluoro-olefin copolymer. When a fluorinated silicate polymer migrates to the coating air interface of a highly fluorinated base coating, the cleanability of a resulting two layer coating will be improved through the formation of fluoro-alcohol during hydrolysis at the interface.

The use of a polyester melamine system to form a stain resistant coating on plastics is also known in the art, such as a reaction product of reactive polyester and a melamine-formaldehyde resin. Another coating composition is a high gloss coating comprising a hydroxyl group-containing fluorocarbon polymer, a blocked aliphatic polyisocyanate cross-linking agent, and a melamine-formaldehyde based resin.

Melamine-formaldehyde resins may also be used with a polyfluoro oxetane oligomer to provide a stain-resistant polyester. The polyesters contain pendant fluorinated units from polyfluorooxetane (comb structures) to create systems when cured. These systems have shown the ability of polyfluorooxentane homo- or copolymers to aggregate at the air interfaces, improving leveling, gloss, scratch and cleanability in many systems. This enhancement of fluorine levels at the interface has made it possible to produce easily cleanable (graffiti resistant) and dry erasable surfaces.

Finally, a copolymerized product of an organic solvent-soluble fluoro-polymer, a polysiloxane, a radically polymerizable monomer having a radically polymerizable double bond and a fluoroalkyl group, and a non-reactive, radically polymerizable monomer is known. The organic solvent-soluble fluoro-polymer contains a radically polymerizable unsaturated bond portion via urethane linkage.

None of these stain-resistant compositions, however, provide a coating composition for natural and synthetic flexible substrates that provides “soft hand,” and a gloss suitable for use with flexible substrates such as vinyl, urethane, leather, polyester, or thermoplastic olefin substrates. The melamine cure of polyesters containing pendant fluoropolymer groups have been shown to provide coatings having improved cleanability but the materials do not have preferred tactile “hand”. This is particularly important for consumer products such as upholstery for furnishings, wall coverings and material used for leathers or synthetics for shoes, handbags, briefcases, luggage, and the like. It is also important for other coated fabric applications where common stains may be deposited on the substrate, but a rigid coating is undesirable. Prior polyester/melamine based coatings require the use of acetone or similar solvents to remove stains. When such coated substrates are cleaned with acetone or the like, the stain is typically removed by removing at least the surface portion of the coating. Such cleaning may be called ablative cleaning.

### BRIEF SUMMARY OF THE INVENTION

The present invention relates to the production of coatings using a fluorine-containing polymer, with the fluorine atoms in the backbone of the polymer and having pendent hydroxyl and/or carboxyl groups, cured with a melamine. The resulting coating formulation, when cured, results in a coated substrate with a “soft hand” and a low gloss appearance when applied and cured to vinyl, urethane, and leather substrates. Substrates coated with this formulation may be cleaned with isopropanol when stained.

It is, therefore, an aspect of the present invention to provide a coating containing a fluoropolymer that has fluorine atoms attached directly to the polymer backbone, cured with a melamine compound, which provides a “soft hand” and a low gloss appearance.

It is also an aspect of the present invention to provide a method for treating a substrate with a stain-resistant composition such that a “soft hand” and a low gloss appearance are provided.

It is also an aspect of the present invention to provide a coated substrate that may be cleaned of ink or other stains with isopropanol instead of acetone or similar solvents.

At least one or more of the foregoing aspects, together with the advantages thereof over the known art relating to stain-resistant compounds, which shall become apparent from the specification which follows, are accomplished by the invention as herein after described and claimed.

In general, the present invention provides a method for increasing the stain resistance of a flexible substrate, the method comprising providing a fluorine-containing ethylene-based copolymer containing fluorine atoms in the main chain of the polymer and pendent or terminal reactive groups selected from the group consisting of carboxyl groups, hydroxyl groups and combinations thereof; providing an amino resin; mixing the copolymer and the amino resin; applying the mixed copolymer and amino resin to a flexible substrate; and curing the mixed copolymer and amino resin to provide a coated substrate having a soft hand wherein the stain resistance of said coated substrate is improved over that of the uncoated substrate.

The present invention also provides a stain resistant composition for coating a flexible substrate comprising an amino resin cured, fluorine-containing, ethylene-based copolymer containing fluorine atoms in the main chain of the polymer and pendent or terminal reactive groups selected from the group consisting of carboxyl groups, hydroxyl groups and combinations thereof, wherein a flexible substrate coated with said stain resistant composition has a soft hand and improved stain resistance over that of the uncoated substrate.

The present invention also provides a stain resistant flexible coated substrate comprising a flexible substrate; and a coating layer comprising an amino resin cured, fluorine-containing, ethylene-based copolymer containing fluorine atoms in the main chain of the polymer and pendent or terminal reactive groups selected from the group consisting of carboxyl groups, hydroxyl groups and combinations thereof, wherein the flexible coated substrate composition has a soft hand and improved resistance to stains over that of the uncoated substrate.

### DETAILED DESCRIPTION OF THE INVENTION

A flexible substrate may be rendered stain resistant without harming the substrate's “hand” by applying a solution containing a fluorine-containing copolymer and an amino resin to the substrate. The fluorine-containing polymer is a fluorinated ethylene copolymer containing pendent or terminal carboxyl or hydroxyl groups and having fluorine atoms attached directly to the main chain (or backbone) of the polymer. The solution also contains an amino crosslinking resin. The solution may also contain an acid catalyst such as para-toluenesulfonic acid (PTSA) or other organic sulfonic acids, aromatic acids, boric acid, phosphoric aid, acid sulfates, hydrochlorides and the like. Additional resins such as polyesters, and optionally components such as silicon dioxide, UV blocking agents, fire retardants, pigments and the like may also be present. In some examples, the solution provides stain resistance without the presence of other stain resistant components such as a polysiloxane. In other examples, the solution consists essentially of a fluorinated ethylene copolymer containing pendent or terminal carboxyl or hydroxyl groups and having halogen atoms attached directly to the main chain (or backbone) of the polymer and an amino resin.

The solution is applied to the substrate and cured. An elevated temperature may be applied to allow the composition to cure. The temperature used may vary with the exact components present in the composition and the substrate to be treated. In one example, the composition is cured at a temperature of about 79° C. This is particularly useful for substrates (such as highly plasticized vinyl) that shrink at higher temperatures (above 93° C.). In other examples, temperatures of about 82° C. or above may be used. In some examples, a cure temperature of as high as 121° C. or higher may be used. As one of skill in the art will recognize, the time allowed for the cure will also vary with the composition and cure temperature. Nonetheless, cure times of at least about 30 seconds to 1 minute will likely be employed.

The fluorine-containing polymer is a fluorinated ethylene copolymer containing pendent or terminal carboxyl or hydroxyl groups. This polymer also has fluorine atoms attached directly to the carbon atoms that form the polymer backbone. Tetrafluoroethylene copolymers, chlorotrifluoroethylene copolymers, trifluoroethylene copolymers, hexafluoroethylene copolymers, and hexafluoropropylene copolymers are believed to be suitable in the present invention, provided that the copolymer contains pendent carboxyl or hydroxyl groups, or a combination of carboxyl and hydroxyl groups. This includes perfluoroakloxyl copolymers of polytetrafluoroethylene, hydroxyl-containing ethylenic fluoropolymers and fluoroalkylcarbonyl containing fluoropolymers. In one example, the fluorine-containing ethylene-based copolymer contains a fluoroolefin structural unit represented by the formula, —CF₂—CFX—, where X may be a fluorine atom, a chlorine atom, a hydrogen atom or a trifluoromethyl group. In another example, the fluorine-containing ethylene-based copolymer contains a β-methyl substituted ∝-olefin represented by the formula —CH₂C(CH₃)R—, wherein R is an alkyl group having 1-8 carbon atoms. This may include polymers based on isobutlylene, 2-methyl-1-butene, 2-methyl-1-hexene and the like. The copolymer may also contain a structural unit derived from a monomer having a chemically curable functional group such as oxirane (epoxy), hydroxy, carboxyl, carbonyl, or it may contain a structural unit derived from a monomer having an ester moiety in a side chain such as acrylates and methacrylates. Other suitable non-fluorine containing copolymers include those based on monomers such as styrene, acrylamide, acrylonitrile, methacrylonitrile, glycidal, methacrylate, hydroxyl, ethyl, methacrylate, and N-methacrylamide.

The fluorine-containing copolymers may have an acid value of between about 0 and about 20 mg KOH/g and a hydroxyl (OH) value between about 5 and about 200 mg KOH/g. Acceptable fluorine-containing copolymers are also commercially available. These include ZEFFLE™ GK resins (Daikin America, Inc.) LUMIFLON™ (Asahi Glass Co.), FLUONATE™ (DAINIPPON Inc. and Chemicals). For example, ZEFFLE™ GK-500 is a tetrafluoroethylene copolymer having an acid value of less than 1 mg KOH/g and an OH value of about 60 Mg KOH/g. ZEFFLE GK-500 has hydroxyl groups pendent from the main polymer chain. ZEFFLE GK-510, which is also a tetrafluoroethylene copolymer, contains carboxyl groups pendent to the main polymer chain and has an acid value of about 9 mg KOH/g and an OH value of about 60 mg KOH/g. LUMIFLON and FLUONATE both contain a chloro-trifluoroether.

Amino crosslinking resins include, for example, urea resins, benzoguanamine resins, melamine resins, and derivatives thereof. In one example, the amino resin is an alkylated melamine resin. In another example, the amino resin is a methylated melamine resin such as hexamethoxymethyl melamine (HMMM). In still another example, the amino resin is HMMM that is modified with styrene allyl alcohol. Such amino resins are commercially available. For example, Resimene™ resins (available from Solutia Inc.), such as Resimene™747 (HMMM), or Resimene™797 (styrene allyl alcohol modified HMMM) may be used. Other Resimene resins include Resimene CE-7103 and Resimene 717. Other examples include Cymel 373, 303 and 385 and Tris(alkoxycarbonylamino)triazine (TACT), Cylink 200 from Cytec.

Flexible substrates may be treated with a single layer of melamine-cured fluoropolymer coating to provide stain resistance to the substrate while maintaining a low gloss appearance and without substantially impairing the flexibility of the substrate. Optimally, the treated flexible substrate does not shrink more than 5 percent across its width when the coating is cured. Vinyls, urethanes, leathers, polyesters, and thermoplastic olefins are non-exclusive examples of flexible substrates that may be treated accordingly to the present invention.

The present invention provides a method for treating a flexible substrate such that at least one of the following stains on the treated flexible substrate are at least partially removed with isopropanol and manual rubbing with a brush, clean tissue or other fabric: black, red or blue solvent-based permanent marker; black, red or blue ink; black or red crayon; mustard; ketchup; lipstick. In one example, a majority of the above stains on a treated flexible substrate may be at least substantially removed with isopropanol and manual rubbing after allowing the stain agents to set for 24 hours. In another example, a majority of the above stains on a treated flexible substrate may be at least substantially removed with isopropanol and manual rubbing after allowing the stain agents to set for 48 hours. In still another example, all of the above stains may be at least substantially removed within one hour of staining. In yet another example, all of the above stains may be at least substantially removed after allowing the stain agents to set for 24 hours. In another example, all of the above stains may be at least substantially removed after allowing the stain agents to set for 48 hours. In another example, all of the above stains may be completely removed after 1 hour of allowing the stain agent to set.

In certain applications, it is highly desirable for a stain-resistant coating to provide stain-resistance with minimal alteration of the appearance of the substrate. This can include maintaining the gloss and the “hand” of the substrate. The hand of the substrate is the aesthetic feel of the substrate, as determined by simple touching of the substrate or by comparing the rigidity of a coated substrate with that of an uncoated substrate. For a flexible substrate, rigidity may be tested by crumpling the substrates by hand or comparing the relative stiffness of coated and uncoated substrates. If the coating cracks when crumpled or if the coated substrate is significantly more rigid than an uncoated one, the coating does not provide a soft hand.

Substrates coated according to the method of the present invention display a low gloss appearance. The term “gloss” refers to the perceived reflection of light by a surface. The gloss of a coating may be measured by methods known in the art. For example, the gloss of a coating may be measured with a gloss meter at a predetermined angle, such as 20, 60 or 85 degrees. Low gloss should be understood to include a measured gloss value of 20 units and below, preferably 10 gloss units and below, and more preferably 5 gloss units and below.

Some stain-resistant coatings require a cure at a relatively high temperature (i.e., 93° C. or greater). This can be detrimental to substrates that shrink at these temperatures. Therefore, in some applications, a relatively low temperature cure (one below 93° C.) would be desirable. In some examples, the method of the present invention provides such a low temperature cure and thereby provides a coated, stain-resistant, coated fabric or laminate with a soft feel or hand, that would not have been possible with previous compositions.

To demonstrate the effectiveness of the present invention, several coating compositions were applied to flexible substrates and cured as follows. The following examples should not be viewed as limiting the scope of the invention. The claims will serve to define the inventions.

In these examples, the following definitions should be understood. CYCAT 4040: p-Toluenesulfonic acid in Isopropanol (Product of CYTEC Industries Inc.);

IPA: Isopropyl alcohol (rubbing alcohol);

IPAc: Isopropyl acetate;

Resimene™ 747: Amino Cross-linker Resin (Product of Solutia Inc.), crosslinking agent;

Resimene™ 797: Amino Cross-linker Resin (Product of Solutia Inc.), crosslinking agent;

ACEMATT TS-100: Highly Dispersed Amorphous Silicon Dioxide (Product of Degussa-AG);

THF: Tetrahydrofuran, solvent;

Hydroxyl-terminated Polyester (Product of OMNOVA Solutions Inc.) (U.S. Pat. No. 4,603,074);

Zeffle™ 500: Tetrafluoroethylene Copolymer (Product of Daikin Industries, Ltd.,);

Zeffle™ 510: Tetrafluoroethylene Copolymer (Product of Daikin Industries, Ltd.,).

In these examples, the following test methods were used.

Gloss: 60° Gloss—The gloss of a coating was measured with a Gardner micro-tri-gloss meter set at a 60° angle of incidence. Three readings were taken across each sample, which were averaged and expressed as gloss unit.

Shrinkage: If the substrate shrinks more than 5 percent across a beginning width of 145 cm, then the shrinkage rating is a failure. If the substrate shrinks less than 5 percent across a beginning width of 145 cm then the shrinkage rating is passing.

Hand: Hand or aesthetic feel of the coating is measured in two manners. (1) Finger-tips are lightly drawn across the substrate to see if it has the same “grip” as a leather and (2) the sheet is crumpled in the tester's hand to determine the relative softness of the material compared to the original substrate, i.e., does the coating stiffen the substrate. If the coating does not stiffen the substrate, then it passes. If the coating cracks or stiffens the substrate, it is given a failure rating.

Staining: Rating the ability to remove a stain after a specified time. The rating is based upon six ratings for each stain between 5 (being the worst) and 0 (being the best).

Ratings: 5 No stain removed

4 Decreased in stain intensity/faded stain present

3 Stain color change (ex. Red ink turning to orange/yellow/pink)

2 Partial removal/discernible stain present

1 Substantial stain removal/slight stain present

0 Complete stain removal/no stain present

Eleven stains were applied to a finished (coated) substrate. The eleven stains were black, red, and blue solvent-based permanent markers (Marks-A-Lot Brand); black, red, and blue ink (Bic Brand Ball Point Pens); black, and red crayons (Crayola Brand); mustard (French's); ketchup (Hunt's); and lipstick (Revlon). The eleven stains were applied and allowed to dry on the substrate for a predetermined period of time. The stains were then cleaned after the allotted times with a tissue and isopropyl alcohol (rubbing alcohol).

Examples 1-8 utilized GK-500 and GK-510 Zeffle™ polyols with melamine resins. The two melamines chosen were Resimene™ 747 and Resimene™ 797. Resimene™ 747 is a methylated melamine. Resimene™ 797 is a methylated melamine modified with a twenty percent solvent soluble styrene allyl alcohol. Resimene 797 can be co-cured with polymers at temperatures as low as about 82′ C. The compositions were applied to substrates and cured. The composition of Examples 1-8 is provided in Table I.

TABLE I
Coating Formulations

| Examples | 1 | 2 | 3 | 4 | 5 | 6 | 7 | 8 |
|---|---|---|---|---|---|---|---|---|
| GK500 | 93.6% | 93.6% | — | — | 89.5% | 88.1% | 78.7% | 55.1% |
| GK510 | — | — | 94.5% | 88.1% | — | — | — | — |
| Resimene ™ 747 | 4.7% | — | 4.7% | — | 8.9% | — | — | — |
| Resimene ™ 797 | — | 4.7% | — | 8.8% | — | 8.8% | 15.7% | 33.1% |
| CYCAT 4040 | 1.7% | 1.7% | 0.8% | 3.1% | 1.6% | 3.1% | 5.6% | 11.8% |

The coatings were formulated in the following manner. The components were weighed into a 100 milliliter (ml) plastic beaker, mixed for one minute, applied via a #10 mayer rod applicator onto a vinyl sheet, and placed into a forced air oven for 1 minute at 121° C. The coating must be dry to the touch and placed on a bench-top for 24 hours before stain testing. Eleven stains, ink (black, red and blue), permanent marker (black, red and blue), crayon (black and red), mustard, ketchup, and lipstick were applied to the coated substrate, and allowed to set for 1 hour before cleaning with isopropanol. All stains on Examples 1-8 were substantially or completely removed with isopropanol.

Examples 1 and 2 showed total cleanability. With a 121° C. cure, Resimene™ GK-500 provided a coating with short term cleanability. Example 3 showed that GK-510 provides a cleanable substrate coating at lower catalyst levels (less than 1 percent). A lower level of catalyst resulted in a softer feeling coated fabric. Example 4 demonstrated that a cleanable coating can be provided with less than 90 percent fluorine-containing polymer (GK-510) in the coating composition. Decreasing levels of fluorine-containing polymer (GK-500) were used in examples 5, 6, 7, and 8. These coatings were also cleanable, showing that increasing amounts of crosslinker can be used with cleanability retained using coating compositions containing as much as about 33 percent crosslinking resin and as little as about 55 percent fluorine-containing polymer.

Comparative Example 1 and Examples 9-12 were formulated in the following manner. The formulation components, as listed in Table II, were weighed into a 100 ml plastic beaker, mixed using a propeller-type blade driven by an electric laboratory mixer for one minute, applied to the flexible vinyl substrate via a #10 wire wound rod, and placed into a forced air oven for 1 minute at 82° C. or 121° C. The coating is then allowed to sit under ambient conditions for 24 hours before applying the stain reagents. The eleven stains described above were applied and allowed to set on the coated vinyl substrate for 1, 24, or 48 hours before cleaning with isopropanol.

TABLE II
Coating Formulations

| | | Comparative | | | | |
|---|---|---|---|---|---|---|
| Ingredients | Solids | Example 1 | Example 9 | Example 10 | Example 11 | Example 12 |
| GK-500 | 60% | — | — | 26.6% | 26.2% | 25.4% |
| GK-510 | 50% | — | 57.8% | — | — | — |
| Hydroxyl terminated | 80% | 36.3% | — | — | 3.5% | 3.4% |
| Polyester | | | | | | |
| Resimene 747 | 100% | 12.5% | 5.8% | — | — | — |
| Resimene 797 | 90-94% | — | — | 16.0% | 17.4% | 16.9% |
| IPA | — | — | 28.9% | 46.5% | 37.8% | 19.8% |
| IPAc | — | 39.7% | — | — | — | 19.8% |
| THF | — | 4.0% | — | — | — | — |
| TS-100 | 100% | 4.8% | 3.5% | 2.9% | 3.5% | 3.4% |
| Cycat 4040 | 40% | 2.77% | 4.0% | 8.0% | 11.6% | 11.3% |
| Cure Temperature | — | 121° C. | 121° C. | 121° C. | 82° C. | 82° C. |

Comparative Example 1 and Examples 9-12 were tested for stain removal, gloss, hand and shrinkage as described above. The results of those tests are listed in Table III.

TABLE III
Testing of Coated Substrates

| | Comparative Example 1 | | | Example 9 | | | Example 10 | | |
|---|---|---|---|---|---|---|---|---|---|
| Staining Agent | 1 hr | 24 hr | 48 hr | 1 hr | 24 hr | 48 hr | 1 hr | 24 hr | 48 hr |
| Red Ballpoint Pen | 3 | 3 | 3 | 0 | 0 | 3 | 0 | 0 | 1 |
| Blue Ballpoint Pen | 0 | 0 | 2 | 0 | 0 | 0 | 0 | 0 | 0 |
| Black Ballpoint Pen | 0 | 0 | 1 | 0 | 0 | 0 | 0 | 0 | 0 |
| Red Permanent Marker | 3 | 3 | 3 | 2 | 3 | 4 | 0 | 2 | 3 |
| Blue Permanent Marker | 0 | 0 | 0 | 0 | 0 | 0 | 0 | 0 | 0 |
| Black Permanent Marker | 0 | 0 | 1 | 0 | 0 | 0 | 0 | 0 | 0 |
| Red Crayon | 0 | 0 | 0 | 0 | 0 | 0 | 0 | 0 | 0 |
| Black Crayon | 0 | 0 | 0 | 0 | 0 | 0 | 0 | 0 | 0 |
| Mustard | 3 | 3 | 3 | 0 | 1 | 3 | 0 | 2 | 2 |
| Ketchup | 0 | 0 | 0 | 0 | 0 | 0 | 0 | 0 | 0 |
| Lipstick | 0 | 0 | 1 | 0 | 0 | 0 | 0 | 0 | 0 |
| Total Stain Rating | 9 | 9 | 14 | 2 | 4 | 10 | 0 | 4 | 6 |

| | | | |
|---|---|---|---|
| Gloss | 2.1 ± 0.3 | 3.2 ± 0.1 | 3.7 ± 0.0 |
| Hand | Fail | Pass | Pass |
| Shrinkage | Fail | Fail | Fail |

| | Results | | | | | |
|---|---|---|---|---|---|---|
| | Example 11 | | | Example 12 | | |
| Staining Agent | 1 hr | 24 hr | 48 hr | 1 hr | 24 hr | 48 hr |
| Red Ballpoint Pen | 0 | 1 | 1 | 0 | 2 | 2 |
| Blue Ballpoint Pen | 0 | 0 | 0 | 0 | 1 | 1 |
| Black Ballpoint Pen | 0 | 0 | 0 | 0 | 0 | 0 |
| Red Permanent Marker | 0 | 2 | 2 | 1 | 3 | 3 |
| Blue Permanent Marker | 0 | 0 | 0 | 0 | 0 | 1 |
| Black Permanent Marker | 0 | 0 | 0 | 0 | 0 | 0 |
| Red Crayon | 0 | 0 | 0 | 0 | 0 | 0 |
| Black Crayon | 0 | 0 | 0 | 0 | 0 | 0 |
| Mustard | 0 | 1 | 2 | 0 | 2 | 2 |
| Ketchup | 0 | 0 | 0 | 0 | 0 | 0 |
| Lipstick | 0 | 0 | 0 | 0 | 0 | 0 |
| Total Stain Rating | 0 | 4 | 5 | 1 | 8 | 9 |

| | | |
|---|---|---|
| Gloss | Approximately 3 | Approximately 3 |
| Hand | Pass | Pass |
| Shrinkage | Pass | Pass |

Examples 9-12 containing fluorinated polyols are more cleanable than the polyester melamine coating as described in U.S. Pat. No. 4,603,074 (Comparative Example 1) when applied to highly plasticized vinyl. Comparative Example 1 was applied in the same manner and cured at the same temperature as Examples 9-12. While Comparative Example 1 provides a low gloss coating, it does not give the necessary flexibility to the system. The coating is subject to cracking when applied and therefore, is considered to have poor “hand”. The high cure temperature required for the commercial coating also causes shrinkage of the substrate.

Example 9 (a GK-510/Resimene™ 747 coating) provides a coating with soft hand and low gloss. With the exception of a red permanent marker stain, all stains were completely removable with isopropanol at 1 hour after staining. However, at 1 hour, even the red marker stain was partially removable. At 24 hours after staining, the red marker stain could be cleaned to the point of a color change of the stain, and a mustard stain was substantially removable. All other stains were still completely removable from the coated substrate. After 48 hours, all stains except red marker, mustard and red ink were completely removable. The removability of stains on a vinyl substrate coated with the composition of Example 9 is superior to that of Comparative Example 1 at each time point. It should also be noted that Comparative Example 1 failed the test for suitable hand while Example 9 did not. Additionally, although Example 9 failed the test for shrinkage, it is envisioned that the composition of Example 9 would be suitable for substrates that do not shrink at 121° C.

Example 10 (a GK-500/Resimene™ 797 coating) also has a “soft hand” and low gloss, and is believed to be suitable for substrates that do not shrink at the cure temperature. At 1 hour after application of staining agents, all stains, including red permanent marker, were completely removable with isopropanol. At 24 hours, red permanent marker and mustard were substantially removable and all other stains were completely removable. As with Example 9, after 48 hours, all stains except red marker, mustard and red ink were completely removable. At this time, red ink and mustard were substantially removable, and red marker stain was altered in color with isopropanol.

Example 11 is a GK-500/Resimene™ 797/hydroxyl terminated polyester coating. It also has improved cleanability over Comparative Example 1. The coating provides soft hand and low gloss and is cured at a lower temperature (82° C.). This lower temperature of cure allows for less than about 5 percent shrinkage with a vinyl substrate. A hydroxyl terminated polyester was used to improve adhesion of the coating to the vinyl substrate. Example 11 also provides complete removability of all stains tested at 1 hour after staining. At 24 hours, all stains were completely removed, except red ink and mustard, which were substantially removed, and red marker, which was partially removed. Even at 48 hours, all stains except red ink, red marker and mustard were completely removed. Red ink was still substantially removed while mustard and red marker were partially removed.

Example 12 (a GK500/Resimene™ 797/hydroxyl terminated polyester coating) also provides soft hand, low gloss, and less than about 5 percent shrinkage with a vinyl substrate. Adding isopropyl acetate prolonged the potlife of the composition by lowering the concentration of solids. Red marker is substantially removed while all other stains are completely removed after 1 hour. Blue ink is substantially removable at 24 and 48 hours after staining while red ink and mustard are partially removable at 24 and 48 hours. Red permanent marker stains change color on cleaning with isopropanol at 24 and 48 hours. Blue permanent marker was substantially removed at 48 hours. All other stains were completely removed at 24 and 48 hours.

Examples 13-15 and Comparative Example 2, were next synthesized, using the components listed in Table IV. Comparative Example 2 is a commercial polyurethane coated onto a flexible PVC substrate which provides “soft hand” properties.

The coatings were formulated in the following manner. All components were weighed out except for the Cycat 4040 to half fill a thirty gallon open steel container having a diameter of about 41 to 51 centimeters (cm). The components were mixed with a 15 cm cowles blade for approximately ten minutes. The formulated coating was covered and moved to the production machine. Ten minutes before application of the coating, the Cycat 4040 was added to the formulation and mixed vigorously by an air mixer at the machine to assure the Cycat 4040 was dispersed well. The mixture was continuously mixed as the coating was delivered to a gravure applicator. The coating was applied to a highly plasticized PVC substrate using a gravure roll and dried/cured by a commercial oven. The commercial oven is 18 meters long. The substrate runs through the ovens at a specified oven temperature and rate or speed. This determines the time of exposure, or resonance time, the coating is subjected to the cure temperature. The coated substrate is allowed to set for a minimum or 24 hours before testing.

TABLE IV
Coating Formulations

| | | Comparative | | | |
|---|---|---|---|---|---|
| Ingredients | Solids | Example 2 | Example 13 | Example 14 | Example 15 |
| Commercial | 15-35% | 100% | — | — | — |
| Polyurethane | | | | | |
| GK-500 | 60% | — | — | 27.7% | 25.4% |
| GK-510 | 50% | — | 57.8% | — | — |
| Hydroxyl | 80% | — | — | 3.7% | 3.4% |
| terminated | | | | | |
| polyester | | | | | |
| Resimene 747 | 100% | — | 5.8% | — | — |
| Resimene 797 | 90-94% | — | — | 18.5% | 16.9% |
| IPA | — | — | 28.9% | 32.4% | 19.8% |
| IPAc | — | — | — | 10.8% | 19.8% |
| TS-100 | 100% | — | 3.5% | 3.7% | 3.4% |
| Cycat 4040 | 40% | — | 4.0% | 3.2% | 11.3% |

Comparative Example 2 is a polyurethane coating having a commercially acceptable tactile feel when applied to highly plasticized vinyl. It is applied by a commercial gravure application and cured at a temperature of 79-88° C. for a resonance time of 1 minute. Example 13, which has a similar composition to that of Example 9, was cured at a temperature 117° C. for a resonance time of 45 seconds. Example 14 was cured at a temperature of about 79° C. for a resonance time of 1 minute. Example 15, which had a similar composition to that of Example 12, was cured at a temperature of about 88° C. for a resonance time of 1 minute. The cleanability of the coated substrates was tested as described above. Test results are reported in Table V.

TABLE V
Testing of Coated Substrates

| | Results | | | | | | | | | | | |
|---|---|---|---|---|---|---|---|---|---|---|---|---|
| | Comparative Example 2 | | | Example 13 | | | Example 14 | | | Example 15 | | |
| Staining Agent (hrs) | 1 | 24 | 48 | 1 | 24 | 48 | 1 | 24 | 48 | 1 | 24 | 48 |
| Red Ballpoint Pen | 3 | 3 | 3 | 0 | 1 | 1 | 2 | 3 | 3 | 1 | 2 | 2 |
| Blue Ballpoint Pen | 3 | 4 | 4 | 0 | 0 | 0 | 0 | 1 | 1 | 0 | 0 | 0 |
| Black Ballpoint Pen | 3 | 4 | 4 | 0 | 0 | 0 | 0 | 0 | 0 | 0 | 0 | 0 |
| Red Permanent Marker | 3 | 4 | 5 | 0 | 2 | 3 | 2 | 3 | 4 | 0 | 2 | 3 |
| Blue Permanent Marker | 2 | 4 | 4 | 0 | 0 | 0 | 0 | 0 | 0 | 0 | 0 | 0 |
| Black Permanent Marker | 3 | 4 | 4 | 0 | 0 | 0 | 0 | 0 | 0 | 0 | 0 | 0 |
| Red Crayon | 0 | 0 | 0 | 0 | 0 | 0 | 0 | 0 | 0 | 0 | 0 | 0 |
| Black Crayon | 0 | 0 | 0 | 0 | 0 | 0 | 0 | 0 | 0 | 0 | 0 | 0 |
| Mustard | 3 | 4 | 4 | 0 | 1 | 2 | 0 | 1 | 2 | 0 | 0 | 2 |
| Ketchup | 0 | 0 | 0 | 0 | 0 | 0 | 0 | 0 | 0 | 0 | 0 | 0 |
| Lipstick | 1 | 2 | 2 | 0 | 0 | 0 | 0 | 1 | 1 | 0 | 0 | 0 |
| Total Stain Rating | 21 | 29 | 30 | 0 | 4 | 6 | 4 | 9 | 11 | 1 | 4 | 7 |

| | | | | |
|---|---|---|---|---|
| Gloss | Approximately 3 | Approximately 3 | Approximately 3 | Approximately 3 |
| Hand | Pass | Pass | Pass | Pass |
| Shrinkage | Pass | Fail | Pass | Pass |

Example 13 (a GK-510/Resimene™ 747 coating) provided a completely cleanable substrate with isopropanol and rubbing after allowing the stain agent to set for 1 hour for all stains tested. At 24 hours, red ink and mustard were substantially removable, while red permanent marker partially removable. At 48 hours, red ink was still substantially removed, while mustard was partially removed and red permanent marker was removed to the point of color change of the stain. All other stains were completely removed at 24 and 48 hours. The coating provided a low gloss and soft hand coating on the substrate. As with Example 9, it is envisioned that the coating composition of Example 13 would be suitable for substrates that do not shrink at the curing temperature (117° C.).

Examples 14 (GK-500/Resimene™ 797 coating) provided a completely cleanable substrate at 1 hour after staining for all stains tested except red ink and red marker. Red ink and marker were partially removed at 1 hour. At 24 hours after staining, red ink and red permanent marker stains changed color, and blue ink, mustard and lipstick stains were substantially removed on cleaning with isopropanol. At 48 hours, blue ink and lipstick were still substantially removed while a mustard stain was partially removed, a red ink stain changed color and a red marker stain was faded. Example 14 provides a coated substrate that has low gloss, soft hand and does not shrink.

Example 15 (another GK-500/Resimene™ 797 coating) was completely cleaned of all stains at 1 hour after staining for all stains tested except red ink, which was substantially removed. At 24 hours, red ink and red marker were partially removed while all other stains were completely removed. At 48 hours after staining, red ink and mustard were partially removed while red marker stain was cleaned to the point of changing the color of the stain. Example 15 also provided a coated substrate that has low gloss, soft hand and does not shrink.

In light of the foregoing, it should thus be evident that the present invention, providing stain resistant compositions, stain resistant flexible coated substrates and method for increasing the stain resistance of flexible substrates substantially improves the art. Although the invention has been exemplified herein, it is to be appreciated that such examples are non-limiting. Accordingly, based upon the disclosure herein of coating compositions herein, those skilled in the art should be able to select alternative copolymers and amino resins with which to practice the invention, as well as other components. Moreover, practice of the present invention is not limited to a particular flexible substrate.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention pertains.

Based upon the foregoing disclosure, it should now be apparent that the present invention will carry out the aspects set forth hereinabove. It is, therefore, to be understood that any variations evident fall within the scope of the claimed invention and thus, the selection of specific component elements can be determined without departing from the spirit of the invention herein disclosed and described. In particular, while the examples presented herein utilized isopropanol as a cleaning agent, other cleaning agents may also be used such as soap and water, a detergent solution or simply water alone.

We claim:

1. A method for increasing the stain resistance of a flexible substrate, the method comprising:
providing a fluorine-containing ethylene-based copolymer containing fluorine atoms in the main chain of the polymer and pendent or terminal reactive groups selected from the group consisting of carboxyl groups, hydroxyl groups and combinations thereof;
providing an amino resin;
mixing said copolymer and said amino resin;
applying the mixed copolymer and amino resin to a flexible substrate;
curing said mixed copolymer and amino resin to provide a coated substrate having a soft hand; wherein the stain resistance of said coated substrate is increased over that of the uncoated substrate.

2. The method of claim 1, wherein said fluorine-containing ethylene-based copolymer is selected from the group consisting of tetrafluoroethylene copolymers, chlorotrifluoroethylene copolymers, hexafluoroethylene copolymers, trifluoroethylene copolymers, hexafluoropropylene-tetrafluoropropylene copolymers, perfluoroalkoxyl copolymers of polytetrafluoroethylene, and hydroxyl- or fluoroalkylcarbonyl-containing ethylenic fluoropolymers.

3. The method of claim 2, wherein said fluorine-containing ethylene-based copolymer is a tetrafluoroethylene copolymer.

4. The method of claim 1, wherein said fluorine-containing ethylene-based copolymer contains a fluoroolefin structural unit represented by the formula —CF₂—CFX—, wherein X is a fluorine atom, a chlorine atom, a hydrogen atom, or a trifluoromethyl group.

5. The method of claim 1, wherein said fluorine-containing ethylene-based copolymer contains a β-methyl substituted ∝-olefin represented by the formula —CH₂C(CH₃)R—, wherein R is an alkyl group having 1-8 carbon atoms.

6. The method of claim 1, wherein said fluorine-containing ethylene-based copolymer contains a structural unit derived from a monomer having a chemically curable functional group.

7. The method of claim 1, wherein said fluorine-containing ethylene-based copolymer contains a structural unit derived from a monomer having an ester moiety in a side chain.

8. The method of claim 1, wherein said fluorine-containing ethylene-based copolymer contains a structural unit derived from a copolymerizable monomer other than a fluorine-containing ethylene-based polymer.

9. The method of claim 1, wherein said fluoroolefin structural unit is derived from a tetrafluoroethylene compound further containing a structural unit derived from a monomer having carboxyl groups.

10. The method of claim 1, wherein said amino resin is an alkylated melamine resin.

11. The method of claim 10, wherein said alkylated melamine is selected from the group consisting of hexamethoxymethyl melamine and polyol modified methylated melamine resin.

12. The method of claim 1, wherein said coated substrate has a soft hand as determined by comparing the stiffness of the coated substrate to an identical uncoated substrate, and the coated substrate is substantially equal in stiffness to said uncoated substrate.

13. The method of claim 1, wherein said flexible substrate is selected from the group consisting of vinyls, urethanes, leathers, polyesters, and thermoplastic olefins.

14. The method of claim 1, wherein said coated substrate has a low gloss appearance.

15. The method of claim 1, wherein said step of curing the mixed copolymer and amino resin comprises heating said mixed copolymer and amino resin to a temperature of at least 79° C. for a predetermined period of time.

16. The method of claim 15, wherein said temperature is no greater than about 93° C.

17. The method of claim 1, wherein increased stain resistance is demonstrated by at least one stain selected from the group consisting of ink, crayon, solvent-based permanent marker, food, and lipstick stains being at least substantially removed with isopropanol within one hour after staining.

18. The method of claim 1, wherein said stain resistance is increased with a single layer of coating on the substrate.

19. A flexible substrate treated according to the method of claim 1.

20. A stain resistant composition for coating a flexible substrate comprising:
an amino resin cured, fluorine-containing, ethylene-based copolymer containing fluorine atoms in the main chain of the polymer and pendent or terminal reactive groups selected from the group consisting of carboxyl groups, hydroxyl groups and combinations thereof,
wherein a flexible substrate coated with said stain resistant composition has a soft hand and improved stain resistance over that of the uncoated substrate.

21. The stain resistant composition of claim 20, wherein said fluorine-containing ethylene-based copolymer is selected from the group consisting of tetrafluoroethylene copolymers, chlorotrifluoroethylene copolymers, hexafluoroethylene copolymers, and trifluoroethylene copolymers, hexafluoropropylene-tetrafluoropropylene copolymers, trifluoroethylene copolymers, hexafluoropropylene-tetrafluoropropylene copolymers, perfluoroalkoxyl copolymers of polytetrafluoroethylene, and hydroxyl- or fluoroalkylcarbonyl-containing ethylenic fluoropolymers.

22. The stain resistant composition of claim 21, wherein said fluorine-containing ethylene-based copolymer is a tetrafluoroethylene copolymer.

23. The stain resistant composition of claim 20, wherein said amino resin is an alkylated melamine resin.

24. The stain resistant composition of claim 23, wherein said alkylated melamine resin is selected from the group consisting of hexamethoxymethyl melamine and polyol-modified methylated melamine resin.

25. The stain resistant composition of claim 20, wherein said flexible substrate is selected from the group consisting of vinyls, urethanes, leathers, polyesters, and thermoplastic olefins.

26. The stain resistant composition of claim 20, wherein said coated substrate is substantially equal in stiffness to said uncoated substrate.

27. The stain resistant composition of claim 20, wherein said coated substrate has a low gloss appearance.

28. A stain resistant flexible coated substrate comprising:
a flexible substrate;
a coating layer for said substrate comprising an amino resin cured, fluorine-containing, ethylene-based copolymer containing fluorine atoms in the main chain of the polymer and pendent or terminal reactive groups selected from the group consisting of carboxyl groups, hydroxyl groups and combinations thereof,
wherein said flexible coated substrate has a soft hand and improved resistance to stains over that of the uncoated substrate.

29. The stain resistant flexible composition of claim 28, wherein said fluorine-containing ethylene-based copolymer is selected from the group consisting of tetrafluoroethylene copolymers, chlorotrifluoroethylene copolymers, hexafluoroethylene copolymers, and trifluoroethylene copolymers, hexafluoropropylene-tetrafluoropropylene copolymers, trifluoroethylene copolymers, hexafluoropropylene-tetrafluoropropylene copolymers, perfluoroalkoxyl copolymers of polytetrafluoroethylene, and hydroxyl- or fluoroalkylcarbonyl-containing ethylenic fluoropolymers.

30. The stain resistant flexible composition of claim 29, wherein said fluorine-containing ethylene-based copolymer is a tetrafluoroethylene copolymer.

31. The stain resistant flexible composition of claim 28, wherein said amino resin is an alkylated melamine resin.

32. The stain resistant flexible composition of claim 31, wherein said alkylated melamine resin is selected from the group consisting of hexamethoxymethyl melamine and polyol-modified methylated melamine resin.

33. The stain resistant flexible composition of claim 28, wherein said flexible substrate is selected from the group consisting of vinyls, urethanes, leathers, polyesters, and thermoplastic olefins.

34. The stain resistant flexible composition of claim 28, wherein said coated substrate is substantially equal in stiffness to said uncoated substrate.

35. The stain resistant flexible composition of claim 28, wherein said coated substrate has a low gloss appearance.
